(19) United States
(12) Patent Application Publication
(10) Pub. No.: US 2026/0184906 A1
(43) Pub. Date: Jul. 2, 2026

(54) ELASTIC HEAT-RESISTANT COMPOSITION WITH MINIMAL DISCHARGE INCLUDING MELAMINE

(71) Applicant: AGENCY FOR DEFENSE DEVELOPMENT, Daejeon (KR)

(72) Inventors: Jinho HYON, Daejeon (KR); Seung Won KO, Daejeon (KR)

(21) Appl. No.: 19/429,702

(22) Filed: Dec. 22, 2025

(30) Foreign Application Priority Data
Dec. 26, 2024 (KR) 10-2024-0197668

(51) Int. Cl. C08L 23/16; C08K 3/06; C08K 5/09; C08K 5/20; C08K 5/3492; C08K 5/40; C08K 5/47; C08K 13/02

(52) U.S. Cl. CPC C08L 23/16; C08K 13/02; C08K 3/06; C08K 5/09; C08K 5/20; C08K 5/34922; C08K 5/40; C08K 5/47; C08L 2201/08; C08L 2205/025; C08L 2205/035; C08L 2207/324; C08L 2312/00

(57) ABSTRACT

The present disclosure relates to an elastic heat-resistant composition for solid propellant rocket motors, and provides an elastic heat-resistant composition in which discharge is minimized by including melamine.

### CROSS-REFERENCE TO RELATED APPLICATION

This application claims priority to Korean Patent Application No. 10-2024-0197668 filed on Dec. 26, 2024, and all the benefits accruing therefrom under 35 U.S.C. § 119, the contents of which are incorporated herein by reference in their entirety.

### BACKGROUND OF THE DISCLOSURE

### Field of the Disclosure

The present disclosure relates to an elastic heat-resistant composition for solid rocket motors. In particular, the present disclosure relates to an elastic heat-resistant composition including melamine in which discharge is minimized.

### Description of the Related Art

A solid rocket motor of a space launch vehicle generally includes a propellant that generates combustion gas, a combustion chamber structure, a liner that bonds the propellant and the combustion chamber, an elastic heat-resistant material that protects the combustion chamber from high-temperature gas, and an ignition device that burns the propellant.

Among these, the heat-resistant material for protecting the combustion chamber is a composite material including a base polymer, fillers, and/or other additives.

For stable combustion of a solid propellant rocket motor in a space launch vehicle, the heat-resistant ablation rate of the elastic heat-resistant material is a structural factor that significantly affects motor performance, and therefore must be as low as possible.

An elastic heat-resistant material exhibiting high heat-resistant ablation performance (i.e., a low ablation rate) typically improves its erosion resistance by generating a high-viscosity molten material and simultaneously forming a strong char layer during combustion.

However, EPDM-based elastic heat-resistant materials developed for this purpose tend to produce rigid and relatively large discharge residues when the char layer is eroded and removed, and such residues are expelled through the nozzle.

In rocket motors having a narrow nozzle region or a pintle structure, these discharged residues may obstruct the corresponding components, causing secondary problems such as performance degradation.

Furthermore, the generation of high-viscosity molten materials and strong char layers interferes with the normal operation of the nozzle components of the solid propellant rocket motor and may cause damage to the components.

Accordingly, development of clean-burn elastic heat-resistant materials that suppress or eliminate the formation of such substances is required.

A clean-burn elastic heat-resistant material must exclude or minimize composition components that generate high-viscosity molten substances, such as silica (SiO₂), iron oxides (FeO, Fe₂O₃, etc.), and aluminum oxides (Al₂O₃, etc.), and must minimize the content of heat-resistant fibers (e.g., aramid fibers, carbon fibers, glass fibers, ceramic fibers), which increase the mechanical strength of the char layer formed on the exposed surface of the elastic heat-resistant material when subjected to high-temperature and high-pressure combustion gas of the solid propellant.

However, when the components that generate high-viscosity molten materials are excluded or minimized and the content of heat-resistant fibers that increase the mechanical strength of the char layer is minimized, this may deteriorate the mechanical and thermal properties of the elastic heat-resistant material or cause problems in adhesion and moldability.

Meanwhile, when high-viscosity molten-material-forming components and/or heat-resistant fibers are excluded or minimized in a clean-burn elastic heat-resistant material and, instead, alkali metal salts (e.g., magnesium hydroxide, ammonium sulfate, ammonium benzoate, magnesium sulfate, and/or calcium oxalate) are included, problems such as erosion or corrosion of special metal components occur due to the alkali metal salts.

In addition, when the thermal erosion resistance is insufficient, a thicker layer of the elastic heat-resistant material must be applied, which results in performance limitations in space-launch vehicle development where weight reduction is emphasized, and leads to reduced efficiency because a sufficient amount of propellant cannot be loaded.

Accordingly, the inventors have developed a clean-burn elastic heat-resistant composition (i.e., an elastic heat-resistant composition in which discharge is minimized) that does not include components that generate high-viscosity precipitates (such as silica and/or heat-resistant fibers) or alkali metal salts that cause erosion or corrosion of special metal components, while not impairing the mechanical properties, thermal properties, adhesion, or moldability required for elastic heat-resistant materials of solid propellant rocket motors, and exhibiting excellent thermal erosion resistance.

### SUMMARY OF THE DISCLOSURE

The purpose of the present disclosure is to provide an elastic heat-resistant material that minimizes discharge by not including components that generate high-viscosity precipitates and not including alkali metal salt components, while maintaining the properties required for elastic heat-resistant materials and exhibiting excellent thermal erosion resistance.

The problems to be solved by the present disclosure are not limited to those mentioned above, and other issues not explicitly stated will be clearly understood by those skilled in the art from the following description.

In order to achieve the purpose, an aspect of the present disclosure provides an elastic heat-resistant composition, comprising: a rubber base material; an additive including melamine; and a vulcanizing agent.

In some exemplary embodiments, the rubber base material may be one or a combination of two or more selected from the group consisting of nitrile rubber (NBR), natural rubber (NR), styrene-butadiene rubber (SBR), chloroprene rubber (CR), butyl rubber (IR), ethylene-propylene rubber (EPDM), Hypalon rubber (CSM), acrylic rubber (ACM/ANM), fluororubber (FPM), silicone rubber (SIU), and butadiene rubber (BR).

In some exemplary embodiments, the ethylene-propylene rubber (EPDM) may be solid ethylene-propylene rubber (EPDM); liquid ethylene-propylene rubber (EPDM); or a combination of solid ethylene-propylene rubber (EPDM) and liquid ethylene-propylene rubber (EPDM).

In some exemplary embodiments, the melamine may be melamine resin, melamine powder, or a combination of melamine resin and melamine powder.

In some exemplary embodiments, the melamine may be present in an amount of 5 to 50 phr based on the rubber base material.

In some exemplary embodiments, the additive may further comprise, as an additional component, one or a combination of two or more selected from the group consisting of oxamide, carbon black, aramid, polyimide (PI), polyetheretherketone (PEEK), polytetrafluoroethylene (PTFE), and polybenzimidazole (PBI).

In some exemplary embodiments, the additional component may be present in an amount of 5 to 100 phr based on the rubber base material.

In some exemplary embodiments, the vulcanizing agent may be one or a combination of two or more selected from the group consisting of zinc oxide (ZnO), stearic acid, mercaptobenzothiazole, dipentamethylene thiuram tetrasulfide, sulfur(S), an ester of saturated fatty acids, RD (2,2,4-Trimethyl-1,2-Hydroquinoline), DM (Dibenzothiazole Disulfide), TRA (Dipentamethylene Thiuram Tetrasulfide), and PVI (N-(Cyclohexylthio)phthalimide).

In some exemplary embodiments, the vulcanizing agent may be present in an amount of 0.1 to 30 phr based on the rubber base material.

Further, another aspect of the present disclosure provides a method for manufacturing an elastic heat-resistant material, using the composition as described above.

Further, still another aspect of the present disclosure provides an elastic heat-resistant material, comprising the composition as described above.

The elastic heat-resistant composition of the present disclosure does not include components that generate high-viscosity precipitates and does not contain alkali metal salts, thereby minimizing discharge during the exhaust of combustion gases from a solid propellant rocket motor.

In addition, the elastic heat-resistant composition of the present disclosure does not include components that erode or corrode special metal components, thereby preventing corrosion of the combustion chamber during exhaust of combustion gases in a solid propellant rocket motor.

In addition, the elastic heat-resistant composition of the present disclosure provides an elastic heat-resistant material that maintains the properties required thereof and exhibits excellent thermal erosion resistance, even though it does not include components that generate high-viscosity precipitates or alkali metal salts.

Furthermore, the elastic heat-resistant composition of the present disclosure can reduce the proportion of the elastic heat-resistant material within the rocket motor by improving ablation efficiency, thereby increasing the propellant mass and enhancing the efficiency of the motor.

The effects of the present disclosure are not limited to the aforementioned effects and should be understood to include all effects that can be inferred from the configurations of the present disclosure described in the detailed description or the claims.

### BRIEF DESCRIPTION OF THE DRAWINGS

FIG. 1 is a conceptual diagram illustrating the ASTM E 285-08 test conditions according to an exemplary embodiment of the present disclosure.

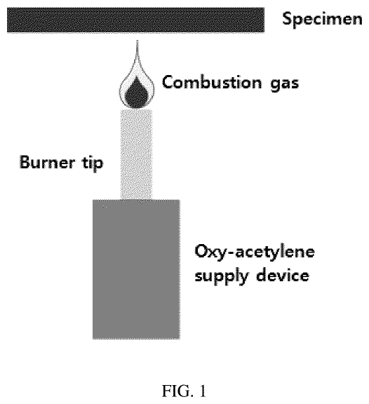

FIG. 2 is a plan view and a front view of a burner tip for the ASTM E 285-08 test according to an exemplary embodiment of the present disclosure.

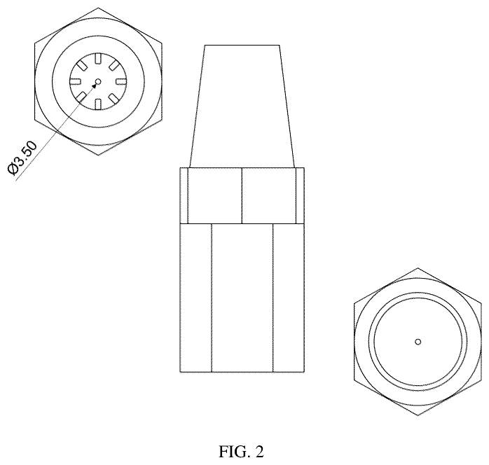

### DETAILED DESCRIPTION OF THE DISCLOSURE

One purpose of the present disclosure is to provide an elastic heat-resistant material which does not contain components that generate high-viscosity precipitates, thereby minimizing exhaust products, while maintaining the physical properties required for an elastic heat-resistant material and exhibiting excellent heat-resistant ablation performance.

Hereinafter, exemplary embodiments of the present disclosure will be described in detail with reference to related drawings.

Advantages and features of the present disclosure and methods to implement them will now be described more fully hereinafter with reference to exemplary embodiments accompanied by drawings.

The present disclosure may, however, be embodied in different forms and should not be construed as limited to the exemplary embodiments set forth herein. Rather, these exemplary embodiments are provided so that this disclosure will be thorough and complete, and will fully convey the scope of the present disclosure to those skilled in the art. The scope of the present disclosure shall be defined only by the scope of claims.

When it is determined that a detailed description about known function or structure relating to the present disclosure may evade the main point of the present disclosure, the detailed description may be omitted.

Hereinafter, a detailed description of the present disclosure is provided.

In order to suppress nozzle blockage caused by combustion of a solid rocket motor, coarse particles generated by thermal decomposition of the elastic heat-resistant material due to combustion gas of the propellant must not be discharged.

To achieve this, the use of additives (or fillers) such as silica (SiO₂), iron oxides (FeO, Fe₂O₃, etc.), and aluminum oxides (Al₂O₃, etc.) and/or heat-resistant fibers [e.g., aramid fibers (for example, Kevlar), carbon fibers, glass fibers, ceramic fibers, etc.] must be excluded or minimized.

However, clean-burn elastic heat-resistant materials having such properties suffer from a significant deterioration in heat-resistant ablation characteristics and/or mechanical properties compared to other elastic heat-resistant materials.

Meanwhile, when a clean-burn elastic heat-resistant material excludes or minimizes components that generate high-viscosity precipitates (the above-mentioned additives such as silica, iron oxides, aluminum oxides, and/or heat-resistant fibers) and instead includes an alkali metal salt, problems arise in that the alkali metal salt causes ablation or corrosion of special metal components.

The present disclosure is intended to solve these problems by providing an elastic heat-resistant composition in which melamine is included instead of components that generate high-viscosity precipitates (the above-mentioned additives such as silica, iron oxides, aluminum oxides, and/or heat-resistant fibers) or alkali metal salts, such that deterioration in heat-resistant ablation characteristics and/or mechanical properties is minimized or such characteristics are improved.

In addition, by not including alkali metal salts, the present disclosure provides an elastic heat-resistant composition that does not cause ablation or corrosion of special metal components.

The present disclosure provides an elastic heat-resistant composition comprising a rubber base material, an additive including melamine, and a vulcanizing agent.

In an elastic heat-resistant composition for a solid propellant, the base material primarily imparts the mechanical properties that the elastic heat-resistant material must inherently possess, and it is desirable that the base material maintain structural stability even under high-temperature and high-pressure environments and minimize chemical reactions with the propellant. The base material may mainly be an elastomer based on rubber.

The rubber base material may be one or a combination of two or more selected from the group consisting of nitrile rubber (NBR), natural rubber (NR), styrene-butadiene rubber (SBR), chloroprene rubber (CR), butyl rubber (IR), ethylene-propylene rubber (EPDM), Hypalon rubber (CSM), acrylic rubber (ACM/ANM), fluororubber (FPM), silicone rubber (SIU), and butadiene rubber (BR).

The rubber base material may include ethylene-propylene rubber (EPDM) or may be ethylene-propylene rubber (EPDM). The rubber base material may be a synthetic rubber mainly composed of ethylene and propylene.

The ethylene-propylene rubber (EPDM) may include a compound represented by the following Chemical Formula 1.

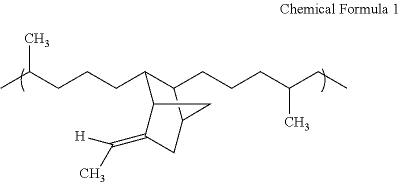

In the EPDM which is a terpolymer of ethylene, propylene, and ethylidene norbornene (ENB), the ethylene may be preferably contained in an amount of 50 to 75 wt %, the propylene may be preferably contained in an amount of 15 to 48.5 wt %, and the ethylidene norbornene may be preferably contained in an amount of 1.5 to 10 wt %, based on the total weight of the EPDM, and the ethylidene norbornene may be more preferably contained in an amount of 5 to 9 wt %.

The ethylene-propylene rubber (EPDM) may be in a solid form or a liquid form, and may be solid ethylene-propylene rubber (EPDM); liquid ethylene-propylene rubber (EPDM); or a combination of solid ethylene-propylene rubber (EPDM) and liquid ethylene-propylene rubber (EPDM).

The solid form of EPDM may be in a solid powder form, and the solid powder form of EPDM may be prepared by pulverizing a polymeric EPDM rubber into a powder form.

The liquid form of EPDM may be polymerized to a low molecular weight so as to maintain a liquid state, and may also function as a plasticizer and/or a lubricant.

The melamine may be included in order to compensate for the deterioration in thermal erosion resistance and/or mechanical properties, which occurs when components that generate high-viscosity precipitates (such as high-viscosity melt-producing components including silica, iron oxides, and aluminum oxides, and/or heat-resistant fibers such as aramid fibers, carbon fibers, glass fibers, and ceramic fibers) or alkali metal salts are excluded from conventional elastic heat-resistant compositions for solid propellants having high thermal erosion resistance.

The melamine may be melamine powder, melamine resin, or a combination of melamine powder and melamine resin. Melamine is a compound having the chemical formula C₃H₆N₆, and the melamine powder may be obtained by pulverizing the melamine, and the melamine resin may be a resin containing melamine, and may be preferably a thermosetting resin produced by bonding melamine with formaldehyde.

The melamine may be contained in an amount of 5 to 50 phr with respect to the rubber base material, and preferably in an amount of 10 to 40 phr or 10 to 30 phr. When the content of the melamine is less than the minimum value, there may be a problem of deterioration in thermal resistance and erosion performance, and when the content exceeds the maximum value, there may be problems of deterioration in thermal resistance and erosion performance and deterioration in processability.

Herein, the unit “phr” used for the composition is an abbreviation of “parts per hundred rubber”, which means that a corresponding component is present at a weight ratio based on 100 parts by weight of rubber (the rubber base material in the present disclosure).

In order to enhance thermal resistance and/or erosion resistance performance of the elastic heat-resistant material according to the present disclosure, the additive may further include, as an additional component, one or a combination of two or more selected from the group consisting of oxamide, carbon black, aramid, polyimide (PI), polyetheretherketone (PEEK), polytetrafluoroethylene (PTFE), and polybenzimidazole (PBI).

The additional component may be contained in an amount of 5 to 100 phr based on the rubber base material, and preferably in an amount of 10 to 100 phr. When the content of the additional component is less than the minimum value, there may be a problem of deterioration in thermal resistance and erosion performance, and when the content exceeds the maximum value, there may be problems of deterioration in thermal resistance and erosion performance and deterioration in processability.

The vulcanizing agent may serve for effective vulcanization of rubber (as vulcanizing agent or accelerator), and may be one or a combination of two or more selected from the group consisting of zinc oxide (ZnO), stearic acid, mercaptobenzothiazole, dipentamethylene thiuram tetrasulfide, sulfur(S), an ester of saturated fatty acids, RD (2,2,4-Trimethyl-1,2-Hydroquinoline), DM (Dibenzothiazole Disulfide), TRA (Dipentamethylene Thiuram Tetrasulfide), and PVI (N-(Cyclohexylthio)phthalimide).

The vulcanizing agent may be contained in an amount of 0.1 to 30 phr based on the rubber base material, and preferably in an amount of 0.5 to 25 phr or 0.5 to 20 phr. When the content of the vulcanizing agent is less than the minimum value, vulcanization may not occur or there may be a problem of deterioration in processability due to a significant decrease in vulcanization rate, and when the content exceeds the maximum value, there may also be a problem of processability due to an issue of controlling the vulcanization rate.

In addition, the present disclosure provides a method for manufacturing an elastic heat-resistant material using the above-described elastic heat-resistant composition.

The method for manufacturing the elastic heat-resistant material of the present disclosure may be performed by using the above-described elastic heat-resistant composition as a raw material.

The detailed description regarding the elastic heat-resistant composition has been previously described and will thus not be repeated hereinafter.

Specifically, the method for manufacturing the elastic heat-resistant material of the present disclosure may be performed by including a mixing step and a vulcanizing step of the above-described elastic heat-resistant composition. In addition, the method for manufacturing the elastic heat-resistant material of the present disclosure may be performed by including a mixing step, an extrusion/forming step, and a vulcanizing step of the above-described elastic heat-resistant composition.

However, the method for manufacturing the elastic heat-resistant material according to the present disclosure is not limited as long as it uses the above-described elastic heat-resistant composition, and may be performed in a conventional manner used in the technical field of the present disclosure.

In addition, the present disclosure provides an elastic heat-resistant material including the above-described elastic heat-resistant composition.

The elastic heat-resistant material of the present disclosure may include the above-described elastic heat-resistant composition as a raw material.

In addition, the elastic heat-resistant material of the present disclosure may be manufactured using the above-described elastic heat-resistant composition and by the above-described method for manufacturing the elastic heat-resistant material.

The detailed description regarding the elastic heat-resistant composition has been previously described and will thus not be repeated hereinafter.

However, the elastic heat-resistant material according to the present disclosure is not limited as long as it includes the above-described elastic heat-resistant composition, and may follow conventionally used manufacturing methods, forms, or uses in the technical field of the present disclosure.

Hereinafter, exemplary embodiments are presented to aid in the understanding of the present disclosure; however, the following embodiments are merely illustrative and are not intended to limit the scope of the present disclosure.

### EXAMPLES AND COMPARATIVE EXAMPLES

A rectangular test specimen was prepared by compounding the formulations listed in Table 1 by roll mixing (milling), followed by vulcanization (160° C. for 60 minutes), and experiments were conducted thereon as described below.

TABLE 1

| | | Formulations (phr) | | | | | | | |
|---|---|---|---|---|---|---|---|---|---|
| | | Comparative | Comparative | | | | | Comparative | Comparative |
| | Component | Example 1 | Example 2 | Example 1 | Example 2 | Example 3 | Example 4 | Example 3 | Example 4 |
| Base | EPDM | 80 | 80 | 80 | 80 | 80 | 80 | 80 | 80 |
| Material | liquid EPDM | 20 | 20 | 20 | 20 | 20 | 20 | 20 | 20 |
| Additive | melamine | | | | | 20 | | | 20 |
| | powder | | | | | | | | |
| | melamine resin | | 5 | 10 | 20 | | 30 | 50 | 30 |
| | Magnesium | 20 | | | | | | | |
| | hydroxide | | | | | | | | |
| | Ammonium | 30 | | | | | | | |
| | sulfate | | | | | | | | |
| | oxamide | 50 | 50 | 50 | 50 | 50 | 50 | 50 | 50 |
| | carbon black | 20 | 20 | 20 | 20 | 20 | 20 | 20 | 20 |
| | aramide chop | 5 | 5 | 5 | 5 | 5 | 5 | 5 | 5 |
| Vulcanizing | ZnO | 5 | 5 | 5 | 5 | 5 | 5 | 5 | 5 |
| Agent | stearic acid | 1 | 1 | 1 | 1 | 1 | 1 | 1 | 1 |
| | mercaptobenzothiazole | 1 | 1 | 1 | 1 | 1 | 1 | 1 | 1 |
| | dipentamethylenc | 0.75 | 0.75 | 0.75 | 0.75 | 0.75 | 0.75 | 0.75 | 0.75 |
| | thiuramtetrasulfide | | | | | | | | |
| | S | 1.5 | 1.5 | 1.5 | 1.5 | 1.5 | 1.5 | 1.5 | 1.5 |

### Experimental Example 1

In order to evaluate heat-erosion resistance, an oxygen/acetylene torch combustion test (O/A Torch) was performed on the prepared test specimens in accordance with ASTM E 285-08, which is applied for internal testing of solid rocket motors, and the results are shown in Table 2.

In particular, under the ASTM E 285-08 test conditions, the burn-through time (sec) was measured using test specimens having a thickness of 6 mm to 8 mm, and a burner tip was designed such that the flow rates of oxygen and acetylene could reach 42 L/min and 34 L/min, respectively, in terms of pressure.

TABLE 2

| | Comparative | Comparative | | | | | Comparative | Comparative |
|---|---|---|---|---|---|---|---|---|
| | Example 1 | Example 2 | Example 1 | Example 2 | Example 3 | Example 4 | Example 3 | Example 4 |
| Erosion | 0.450~0.500 | 0.550~0.600 | 0.400~0.450 | 0.400~0.450 | 0.450~0.500 | 0.550~0.600 | 0.600~0.650 | 0.600~0.650 |
| Rate (mm/s) | | | | | | | | |

According to Table 2, it was confirmed that even when melamine was used instead of components that generate high-viscosity precipitates or alkali metal salts, discharge during exhaust of combustion gases was minimized by not including components that generate high-viscosity precipitates or alkali metal salts, and that the thermal erosion rate was sufficiently low. Although performance requirements may vary depending on the type of rocket motor, the results showed that the composition sufficiently satisfies the applicable range for current systems.

### Experimental Example 2

In order to confirm whether the composition was developed within a range that meets general mechanical property targets of elastic heat-resistant materials, tensile strength, elongation, and hardness tests were conducted in a temperature range of −40° C. to 60° C. in accordance with the vulcanized rubber test method of KS M 6518 (test temperatures: −40° C./0° C./20° C./60° C.), and the results are shown in Table 3.

TABLE 3

| | Standard | Comparative | Comparative | | | | | Comparative | Comparative |
|---|---|---|---|---|---|---|---|---|---|
| | Value | Example 1 | Example 2 | Example 1 | Example 2 | Example 3 | Example 4 | Example 3 | Example 4 |
| Tensile | 50 or more | 60-80 | 60-80 | 60-80 | 60-80 | 60-80 | 60-80 | 60-80 | 60-80 |
| Strength | | | | | | | | | |
| (kg/cm²) | | | | | | | | | |
| Elongation | 50 or more | 300-400 | 300-400 | 300-400 | 300-400 | 300-400 | 300-400 | 300-400 | 300-400 |
| (%) | | | | | | | | | |
| Hardness | 60 or more | 70-75 | 70-75 | 70-75 | 70-75 | 70-75 | 70-75 | 70-75 | 70-75 |
| (Shore-A) | | | | | | | | | |

According to Table 3, even when melamine is used instead of components that generate high-viscosity precipitates or alkali metal salts, discharge during combustion gas exhaust is minimized by not including components that generate high-viscosity precipitates or alkali metal salts, and the tensile strength, elongation, and hardness satisfied the standard values required for elastic heat-resistant materials.

In the above, specific exemplary embodiments of the elastic heat-resistant composition with minimal discharge including melamine resin according to the present disclosure have been described. However, it will be apparent that various modifications can be made without departing from the scope of the present disclosure.

Therefore, the scope of the present disclosure should not be limited to the described exemplary embodiments, but should be defined by the following claims and their equivalents.

That is, the foregoing embodiments are illustrative in all aspects and not limiting, and the scope of the present disclosure should be indicated by the claims described below rather than the detailed description. All modifications and variations derived from the meaning, scope, and equivalent concepts of the claims should be construed as being included within the scope of the present disclosure.

The elastic heat-resistant composition of the present disclosure has the effect of minimizing discharge during combustion gas exhaust of a solid propellant rocket motor by not including components that generate high-viscosity precipitates.

In addition, the elastic heat-resistant composition of the present disclosure has the effect of providing an elastic heat-resistant material that exhibits excellent thermal erosion resistance and maintains the properties required for elastic heat-resistant materials, even without including components that generate high-viscosity precipitates.

What is claimed is:

1. An elastic heat-resistant composition, comprising:
a rubber base material;
an additive including melamine; and
a vulcanizing agent.

2. The elastic heat-resistant composition of claim 1,
wherein the rubber base material is one or a combination of two or more selected from the group consisting of nitrile rubber (NBR), natural rubber (NR), styrene-butadiene rubber (SBR), chloroprene rubber (CR), butyl rubber (IR), ethylene-propylene rubber (EPDM), Hypalon rubber (CSM), acrylic rubber (ACM/ANM), fluororubber (FPM), silicone rubber (SIU), and butadiene rubber (BR).

3. The elastic heat-resistant composition of claim 2,
wherein the ethylene-propylene rubber (EPDM) is
solid ethylene-propylene rubber (EPDM);
liquid ethylene-propylene rubber (EPDM); or
a combination of solid ethylene-propylene rubber (EPDM) and liquid ethylene-propylene rubber (EPDM).

4. The elastic heat-resistant composition of claim 1,
wherein the melamine is melamine resin, melamine powder, or a combination of melamine resin and melamine powder.

5. The elastic heat-resistant composition of claim 1,
wherein the melamine is present in an amount of 5 to 50 phr based on the rubber base material.

6. The elastic heat-resistant composition of claim 1,
wherein the additive further comprises, as an additional component, one or a combination of two or more selected from the group consisting of oxamide, carbon black, aramid, polyimide (PI), polyetheretherketone (PEEK), polytetrafluoroethylene (PTFE), and polybenzimidazole (PBI).

7. The elastic heat-resistant composition of claim 6,
wherein the additional component is present in an amount of 5 to 100 phr based on the rubber base material.

8. The elastic heat-resistant composition of claim 7,
wherein the vulcanizing agent is one or a combination of two or more selected from the group consisting of zinc oxide (ZnO), stearic acid, mercaptobenzothiazole, dipentamethylene thiuram tetrasulfide, sulfur(S), an ester of saturated fatty acids, RD (2,2,4-Trimethyl-1,2-Hydroquinoline), DM (Dibenzothiazole Disulfide), TRA (Dipentamethylene Thiuram Tetrasulfide), and PVI (N-(Cyclohexylthio)phthalimide).

9. The elastic heat-resistant composition of claim 8,
wherein the vulcanizing agent is present in an amount of 0.1 to 30 phr based on the rubber base material.

10. A method for manufacturing an elastic heat-resistant material,
using the composition of claim 1.

11. An elastic heat-resistant material,
comprising the composition of claim 1.
